(19) United States
(12) Patent Application Publication
(10) Pub. No.: US 2025/0136147 A1
(43) Pub. Date: May 1, 2025

(54) REMOTE DRIVING CONTROL METHOD AND APPARATUS, COMPUTER-READABLE MEDIUM, AND ELECTRONIC DEVICE

(71) Applicant: TENCENT TECHNOLOGY (SHENZHEN) COMPANY LIMITED, Shenzhen (CN)

(72) Inventors: Yuhang JIA, Shenzhen (CN); Yixue LEI, Shenzhen (CN); Yipeng ZHANG, Shenzhen (CN); Yunfei ZHANG, Shenzhen (CN)

(73) Assignee: TENCENT TECHNOLOGY (SHENZHEN) COMPANY LIMITED, Shenzhen (CN)

(21) Appl. No.: 19/004,940

(22) Filed: Dec. 30, 2024

Related U.S. Application Data
(63) Continuation of application No. PCT/CN2023/090099, filed on Apr. 23, 2023.

(30) Foreign Application Priority Data
Jul. 7, 2022 (CN) 202210795869.4

(51) Int. Cl. B60W 60/00; B60W 30/14; B60W 50/00; B60W 50/14

(52) U.S. Cl. CPC B60W 60/001; B60W 30/143; B60W 50/0097; B60W 50/14; B60W 2556/45; B60W 2756/10

(57) ABSTRACT

A remote driving control method includes: obtaining vehicle status data of a vehicle and environmental data of a road condition of the vehicle; determining first data for making driving decisions and second data for constructing a simulated environment corresponding to the road condition, based on the vehicle status data and the environmental data; transmitting the first data to a remote driving server; transmitting the second data to a target server, the target server and the remote driving server being connected via a network; receiving a first vehicle control instruction from the remote driving server; and transmitting the first vehicle control instruction to the vehicle, wherein the first vehicle control instruction is generated based on the first data and driving assistance information transmitted from the target server, and wherein the driving assistance information is generated based on the constructed simulated environment.

### CROSS REFERENCE TO RELATED APPLICATIONS

This application is a continuation application of International Application No. PCT/CN2023/090099 filed on Apr. 23, 2023, which claims priority to Chinese Patent Application No. 202210795869.4 filed with China National Intellectual Property Administration (CNIPA) on Jul. 7, 2022, the disclosures of each being incorporated herein by reference in their entireties.

### FIELD

The disclosure relates to the field of computer and communication technologies, and specifically, to a remote driving control method and apparatus, a computer-readable medium, and an electronic device.

### BACKGROUND

Remote driving is a technology that uses mobile communication to control a vehicle over a long distance and may resolve operations in dangerous and harsh environments (such as earthquake relief, toxic environments, dangerous tunnels, fire-fighting and rescue, cliff clearing, and explosion site cleanup). The development of the fifth-generation mobile communication technology (5G) network provides support for such a “high-bandwidth and low-latency” driving method.

A principle of remote driving is to transmit a driving instruction to the vehicle in a downward direction through the network. However, to transfer a driving instruction, status parameters of the vehicle and visual information may need to be transmitted to a remote driving server in an upward direction through the network, and the remote driving technology may depend on the network status. Therefore, solutions for optimizing network quality are desired, and such solutions may also help ensure the safety of remote driving.

### SUMMARY

According to some embodiments, a remote driving control method and apparatus, a computer-readable medium, and an electronic device are provided.

According to some embodiments, a remote driving control method includes: obtaining vehicle status data of a vehicle and environmental data of a road condition of the vehicle; determining first data for making driving decisions and second data for constructing a simulated environment corresponding to the road condition, based on the vehicle status data and the environmental data; transmitting the first data to a remote driving server; transmitting the second data to a target server, the target server and the remote driving server being connected via a network; receiving a first vehicle control instruction from the remote driving server; and transmitting the first vehicle control instruction to the vehicle, wherein the first vehicle control instruction may be generated based on the first data and driving assistance information transmitted from the target server, and wherein the driving assistance information may be generated based on the constructed simulated environment.

According to some embodiments, a remote driving control apparatus includes: at least one memory configured to store computer program code; at least one processor configured to read the program code and operate as instructed by the program code, the program code including: obtaining code configured to cause at least one of the at least one processor to obtain vehicle status data of a vehicle and environmental data of a road condition of the vehicle; first determining code configured to cause at least one of the at least one processor to determine first data configured for making driving decisions and second data configured for constructing a simulated environment corresponding to the road condition, based on the vehicle status data and the environmental data; transmitting code configured to cause at least one of the at least one processor to: transmit the first data to a remote driving server, and transmit the second data to a target server, the target server and the remote driving server being connected via a network; first receiving code configured to cause at least one of the at least one processor to receive a first vehicle control instruction from the remote driving server; and first sending code configured to cause at least one of the at least one processor to transmit the first vehicle control instruction to the vehicle, wherein the first vehicle control instruction may be generated based on the first data and driving assistance information transmitted from the target server, and wherein the driving assistance information may be generated according to the constructed simulated environment.

According to some embodiments, a non-transitory computer-readable storage medium, storing computer code which, when executed by at least one processor, causes the at least one processor to at least: obtain vehicle status data of a vehicle and environmental data of a road condition of the vehicle; determine first data configured for making driving decisions and second data configured for constructing a simulated environment corresponding to the road condition, based on the vehicle status data and the environmental data; transmit the first data to a remote driving server; transmit the second data to a target server, the target server and the remote driving server being connected via a network; receive a first vehicle control instruction from the remote driving server; and transmit the first vehicle control instruction to the vehicle, wherein the first vehicle control instruction may be generated based on the first data and driving assistance information transmitted from the target server, and wherein the driving assistance information may be generated according to the constructed simulated environment.

The foregoing and following descriptions are for illustration and explanation purposes and are not intended to limit the scope of the disclosure.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture of remote driving according to some embodiments.

FIG. 2 is a schematic diagram of a system architecture according to some embodiments.

FIG. 3 is a flowchart of a remote driving control method according to some embodiments.

FIG. 4 is a flowchart of a remote driving control method according to some embodiments.

FIG. 5 is a flowchart of a remote driving control method according to some embodiments.

FIG. 6 is a flowchart of a remote driving control method according to some embodiments.

FIG. 7 is a flowchart of a remote driving control method according to some embodiments.

FIG. 8 is a block diagram of a remote driving control apparatus according to some embodiments.

FIG. 9 is a block diagram of a remote driving control apparatus according to some embodiments.

FIG. 10 is a block diagram of a remote driving control apparatus according to some embodiments.

FIG. 11 is a schematic structural diagram of a computer system adapted to implement an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Some embodiments are described with reference to the accompanying drawings. However, some embodiments can be implemented in various forms, and the disclosure is not to be understood as being limited to these examples. Some embodiments are merely provided to convey examples to a person skilled in the art.

In addition, the features, structures, or characteristics described may be combined in some embodiments in any appropriate manner. In the following descriptions, details are provided to provide understanding of the disclosure. However, a person of ordinary skill in the art is to be aware that, the technical solutions may be implemented without all features, or with one or more details omitted, or with other methods, components, apparatuses, steps, or the like used.

The block diagrams shown in the accompanying drawings may or may not correspond to physically independent entities. For example, the functional entities may be implemented in a software form, or in one or more hardware modules or integrated circuits, or in different networks and/or processor apparatuses and/or microcontroller apparatuses.

The flowcharts shown in the accompanying drawings are merely exemplary and do not need to be performed in the described order. For example, some operations or steps may be further divided, while some operations or steps may be combined or partially combined. Therefore, an actual execution order may change.

“A plurality of” means two or more. The term “and/or describes an association relationship between associated objects and represents that three types of relationships may exist. For example, A and/or B may represent the following three cases: only A exists, both A and B exist, and only B exists. The character “/” may indicate that the associated objects are in an “or” relationship.

Artificial intelligence (AI) involves a theory, a method, a technology, and an application system that use a digital computer or a machine controlled by the digital computer to simulate, extend, and expand human intelligence, perceive an environment, acquire knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. AI technologies may include technologies such as a sensor, a dedicated AI chip, cloud computing, distributed storage, a big data processing technology, an operating/interaction system, and electromechanical integration. AI software technologies include several major directions such as a computer vision (CV) technology, a speech processing technology, a natural language processing technology, machine learning/deep learning, automated driving, and intelligent transportation.

The automated driving technology relies on AI, visual computing, and a radar apparatus to cooperate with a global positioning system (GPS) to allow a computer to autonomously and safely perform an operation on a motor vehicle without any human active operation. The automated driving technology usually includes high-definition maps, environment sensing, behavioral decision-making, route planning, motion control, and other technologies. The automated driving technology has a wide range of application prospects.

Remote driving is a technology between automated driving and manual driving. Remote driving is a technology that uses mobile communication to control a vehicle over a long distance, and includes a human remote control (HRC) mode and a machine remote control (MRC) mode. As the name suggests, HRC means remote driving by humans, and MRC means remote driving by machines. MRC is a type of automated driving.

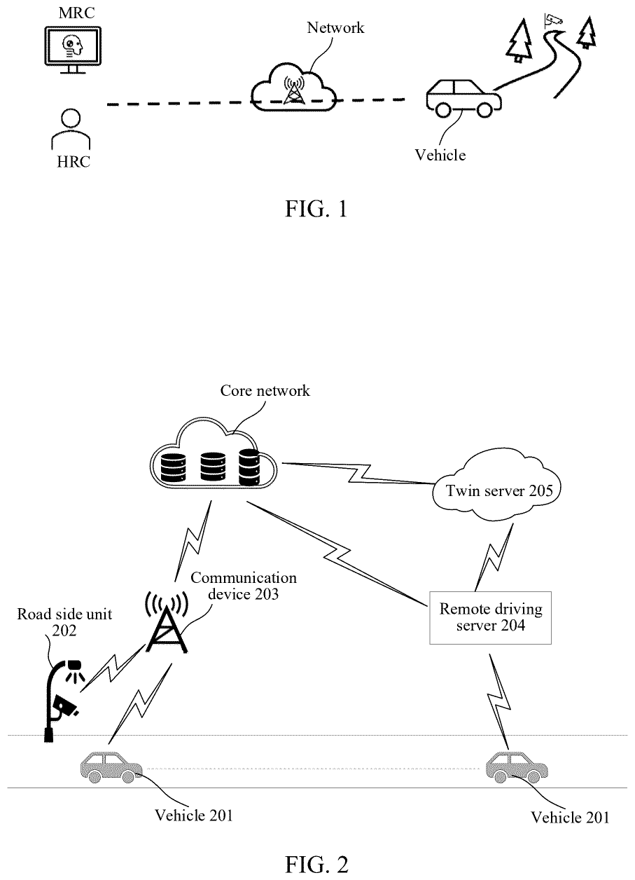

As shown in FIG. 1, in a remote driving scene, there may be two remote driving modes: MRC and HRC. In the HRC mode, a driver needs to obtain video information within a visual field of a remote vehicle through a network. Therefore, a relatively large uplink network bandwidth may be required. In the MRC driving mode, vehicle-end information may be transmitted by using structured data or raw format data. Therefore, a relatively small network uplink bandwidth is occupied. However, in terms of a downlink control instruction, network transmission requirements of the HRC mode and the MRC mode are similar.

For a 5G system, uplink transmission may be more challenging than downlink transmission, and for 5G remote driving, a network data transmission requirement may be higher as driving safety is involved. In addition, 5G remote driving also may have high requirements on jitter characteristics of network transmission, as jitter affects the algorithm design of the vehicle and the cloud. Accordingly, remote driving technology may depend on the network status. Therefore, network quality of remote driving may need to be optimized to ensure the safety of remote driving.

In an application scenario, as shown in FIG. 2, a vehicle 201 may be a remotely driven vehicle that travels along a road under remote control. A road side unit (RSU) 202 is provided on the road side. The vehicle 201 or the RSU 202 may detect, through a sensing device (such as a camera, radar, or other sensors), information about anomalies of other surrounding traffic participants (such as vehicles, pedestrians, or cyclists) or roads, such as at least one of road traffic events (including traffic accidents), vehicle anomalies (speeding, driving out of a lane, wrong-way driving, irregular driving, abnormal stationarity, or the like), road obstacles (such as a rockfall, scattered objects, or dead branches), and road surface statuses (such as water accumulation or icing), and other information (collectively referred to as environmental data below), and process and then transmit the detected information to a communication device 203. The communication device 203 refers to an active communication device that can serve as a transmitter, for example, an access network device (such as a base station device) or a Wi-Fi device. In addition, the vehicle 201 may further send vehicle status data thereof, such as at least one of a speed, acceleration, a direction angle, a network status, and other data, to the communication device 203. The network status of the vehicle 201 may be detected by the vehicle 201 and then sent to the communication device 203, or may be a network status of the vehicle 201 that is detected by the communication device 203 proactively.

A core network shown in FIG. 2 is responsible for user authentication, authorization, and data forwarding, and includes a 4G/5G core network, a 5G cloud-based core network, or the like. A twin server 205 is mounted close to a remote driving server 204 or has a logical location close to the remote driving server 204, and is responsible for scene rendering processing to generate a road environment of the vehicle 201, then presenting the road environment of the vehicle 201, and performing situational awareness operations such as simulation deduction and calculation.

Based on receiving the vehicle status data and environmental data of a road condition of the vehicle that are sent by at least one of the vehicle 201 and the RSU 202, the communication device 203 may forward such data to the remote driving server 204 and the twin server 205 through the core network. In some embodiments, the communication device 203 may send first data configured for making driving decisions in the vehicle status data and the environmental data to the remote driving server 204, and send second data configured for constructing a simulated environment corresponding to the road condition of the vehicle 201 to the twin server 205 in communication connection with the remote driving server 204.

Subsequently, the twin server 205 may construct, according to the second data, the simulated environment corresponding to the road condition of the vehicle 201, then generate corresponding driving assistance data (for example, at least one of a real-time video stream of the simulated environment, prediction information for the road condition of the vehicle, driving advice information obtained through analysis, and network prediction information of the vehicle), and send the driving assistance data to the remote driving server 204.

In some embodiments, the remote driving server 204 may directly perform analysis and determining (prediction) on a traveling situation of the vehicle 201 according to the received first data, and notify the vehicle 201 of a control instruction (for example, at least one of slowing down, reducing a camera bit rate, pulling over, and switching driving modes) obtained through analysis. For example, during remote driving of the vehicle 201 in an HRC mode, if it is found that the network status of the vehicle 201 deteriorates, a remote driving mode of the vehicle 201 may be switched from the HRC mode to an MRC mode, to avoid a possible driving risk caused by using the HRC mode and the network status being poor. For another example, during remote driving of the vehicle 201 in an MRC mode, if it is found that the network status of the vehicle 201 is excellent, a remote driving mode of the vehicle 201 may be switched from the MRC mode to an HRC mode based on the vehicle 201 approaching a road condition. For still another example, during remote driving of the vehicle 201 in an MRC mode, if it is found that the network status of the vehicle 201 deteriorates and the vehicle 201 is about to pass through a road condition, the vehicle 201 may be controlled to stop in a safe region and wait for the network status to become better before starting out, to reduce the safety risk.

In some embodiments, the remote driving server 204 may generate a control instruction with reference to the driving assistance data sent by the twin server 205 and deliver the control instruction to the vehicle 201, so that the vehicle 201 performs a corresponding operation according to the control instruction sent by the remote driving server 204. The remote driving server 204 may deliver the control instruction to the vehicle 201 through the core network and a communication device of an access network.

In some embodiments, environment construction and analysis and processing tasks of the road condition of the vehicle can be performed on the twin server 205. Therefore, the impact on a network bandwidth of the remote driving server 204 can be alleviated by reducing a volume of data transmitted to the remote driving server 204, thereby reducing the probability of driving risks caused by network quality deterioration. The remote driving server 204 generates a vehicle control instruction according to the first data and driving assistance information fed back by the twin server 205, so that the remote driving server 204 can reach remote driving decisions based on a larger amount of more comprehensive information, thereby helping improve the safety of remote driving.

Some embodiments involve the vehicle status data of the vehicle, the environmental data of the road condition, and other relevant data. Some embodiments may require the permission or consent of the relevant objects, and the collection, use, and processing of the relevant data, and therefore may need to comply with relevant laws, regulations, and standards of relevant countries and regions.

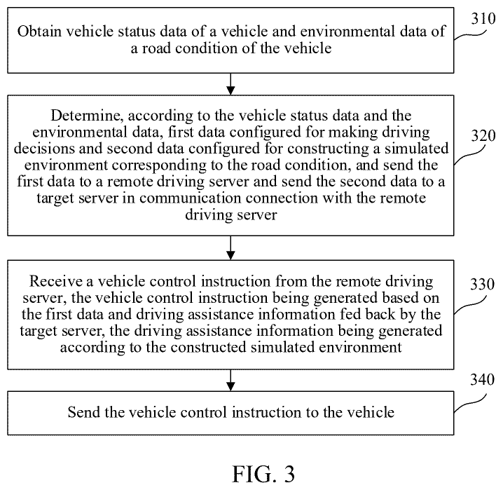

FIG. 3 is a flowchart of a remote driving control method according to some embodiments. The remote driving control method may be performed by a network side device. The network side device may be an access network device, for example, the communication device 203 shown in FIG. 2. Referring to FIG. 3, the remote driving control method includes at least 310 to 340. A detailed description is as follows:

310: Obtain vehicle status data of a vehicle and environmental data of a road condition of the vehicle.

In some embodiments, during 310, vehicle status data and environmental data detected by a vehicle-mounted device disposed on the vehicle may be received. The vehicle-mounted device may be, for example, at least one of a vehicle-mounted camera, light detection and ranging (LiDAR) sensor, speed sensor, distance sensor, or global positioning system (GPS) device, or may be a mobile terminal located in the vehicle, such as at least one of a smartphone, a tablet computer, or a wearable device.

In some embodiments, during 310, vehicle status data and environmental data detected by an RSU configured on a road section on which the vehicle is traveling may be received. The RSU may be, for example, at least one of a roadside camera, distance sensor, millimeter wave radar, or LiDAR.

In some embodiments, during 310, both vehicle status data and environmental data detected by a vehicle-mounted device disposed on the vehicle, and vehicle status data and environmental data detected by an RSU configured on a road section on which the vehicle is traveling may be received.

In some embodiments, the vehicle status data may be, for example, at least one of a speed, acceleration, direction angle, vehicle location information, network status, and other data of a vehicle. The environmental data of the road condition of the vehicle may be, for example, information about anomalies of other traffic participants (such as vehicles, pedestrians, or cyclists) surrounding the vehicle or roads, such as at least one of road traffic events (including traffic accidents), vehicle anomalies (speeding, driving out of a lane, wrong-way driving, irregular driving, abnormal stationarity, or the like), road obstacles (such as a rockfall, scattered objects, or dead branches), road surface statuses (such as water accumulation or icing), and other information.

In some embodiments, in addition to being sent by the vehicle, the network status of the vehicle may also be detected by the network side device. Certainly, the network status of the vehicle may also be both sent by the vehicle and detected by the network side device.

In some embodiments, the network status may include at least one of the following: a signal to interference plus noise ratio (SINR), a received signal strength indicator (RSSI), reference signal received power (RSRP), reference signal received quality (RSRQ), latency information, a throughput, a physical downlink shared channel transport block size, a modulation and coding scheme, a rate of a downloaded fragment (during transmission, data can be divided into a plurality of portions for transmission, and each portion is referred to as a fragment), duration of the downloaded fragment, a bit rate of an optional fragment, a size of a buffer, a quantity of remaining undownloaded fragments, and a bit rate for downloading a previous fragment. In some embodiments, the network status may use the following information as mandatory information: an SINR, an RSSI, RSRP, RSRQ, latency information, a throughput, a physical downlink shared channel transport block size, and a modulation and coding scheme; and use the following information as optional information: a rate of a downloaded fragment, duration of the downloaded fragment, a bit rate of an optional fragment, a size of a buffer, a quantity of remaining undownloaded fragments, and a bit rate for downloading a previous fragment.

320: Determine, according to the vehicle status data and the environmental data, first data configured for making driving decisions and second data configured for constructing a simulated environment corresponding to the road condition, and send the first data to a remote driving server and send the second data to a target server in communication connection with the remote driving server.

In some embodiments, structured data and unstructured data may be selected from the vehicle status data and the environmental data. Then, the unstructured data is used as the first data and sent to the remote driving server, and the structured data is used as the second data or the structured data and the unstructured data are used as the second data and sent to the target server.

The unstructured data is data that has an irregular or incomplete data structure, does not have a pre-defined data model, and is inconvenient to be represented by using a two-dimensional logic table of a database, and may include at least one of an image, audio, a video, a document, text, and a picture. Correspondingly, the structured data is data that has a regular or complete data structure, has a pre-defined data model, and is convenient to be represented by using a two-dimensional logic table of a database.

For example, the RSU detects that three vehicles are around the vehicle, located 10 meters in front of the vehicle, adjacent to the vehicle on a left lane, and five meters behind the vehicle on a right lane, respectively. The RSU may process the information into structured data for transmission, which may be, for example, “vehicle 1—in front on the same lane—10 meters; vehicle 2—on the left lane—0 meters; and vehicle 3—behind on the right lane—5 meters”.

The unstructured data is easy to be understood by a remote driver. Therefore, the unstructured data may be sent to the remote driving server, so that the driver at the remote driving server analyzes the data to obtain a vehicle control instruction, and then sends the instruction to the vehicle. The structured data is unintelligible data stored in a database, and therefore, may be sent to and parsed by the target server, and the target server constructs a simulated environment corresponding to the road condition of the vehicle.

330: Receive a vehicle control instruction from the remote driving server, the vehicle control instruction being generated based on the first data and driving assistance information fed back by the target server, the driving assistance information being generated according to the constructed simulated environment.

For example, the vehicle control instruction generated by the remote driving server based on the first data and the driving assistance information fed back by the target server may be received. The driving assistance information is generated by the target server according to the constructed simulated environment.

In some embodiments, the driving assistance information fed back by the target server may be, for example, at least one of a real-time video stream of the simulated environment, prediction information for the road condition of the vehicle, driving advice information obtained through analysis, and network prediction information of the vehicle.

In some embodiments, the vehicle control instruction may be at least one of slowing down, reducing a data transmission bit rate, reducing a video capturing bit rate of a camera, stopping in a specified region (such as pulling over), and switching driving modes (such as switching MRC to HRC, or switching HRC to MRC).

Specifically, if it is determined, according to the first data and the driving assistance information, that a traveling status and the network status of the vehicle do not match a current remote driving mode of the vehicle, a control instruction on switching the remote driving mode of the vehicle may be generated. For example, during remote driving of the vehicle in an HRC mode, if it is found that the network status of the vehicle deteriorates, the remote driving mode of the vehicle may be switched from the HRC mode to an MRC mode, to avoid a possible driving risk caused by using the HRC mode and the network status being poor. For another example, during remote driving of the vehicle in an MRC mode, if it is found that the network status of the vehicle is excellent, the remote driving mode of the vehicle may be switched from the MRC mode to an HRC mode based on the vehicle approaching a road condition. For still another example, during remote driving of the vehicle in an MRC mode, if it is found that the network status of the vehicle deteriorates and the vehicle is about to pass through a road condition, the vehicle may be controlled to stop in a safe region and wait for the network status to become better before starting out, to reduce the safety risk.

If the network status of the vehicle indicates that current network communication quality of the vehicle is lower than a set threshold, a control instruction on reducing a data transmission bit rate of the vehicle may be generated. If the traveling status of the vehicle indicates that there is a driving risk on a road section on which the vehicle is traveling, a control instruction on reducing a traveling speed of the vehicle may be generated, or a control instruction on parking in a specified region may be generated.

340: Send the vehicle control instruction to the vehicle. After receiving the vehicle control instruction, the vehicle may perform a corresponding operation, such as speeding up, slowing down, or pulling over.

In some embodiments shown in FIG. 3, environment construction and analysis and processing tasks of the road condition of the vehicle can be performed on the target server. Therefore, the impact on a network bandwidth of the remote driving server can be alleviated by reducing a volume of data transmitted to the remote driving server, thereby reducing the probability of driving risks caused by network quality deterioration. The remote driving server generates the vehicle control instruction according to the first data and the driving assistance information fed back by the target server, so that the remote driving server can reach remote driving decisions based on a larger amount of more comprehensive information, thereby helping improve the safety of remote driving.

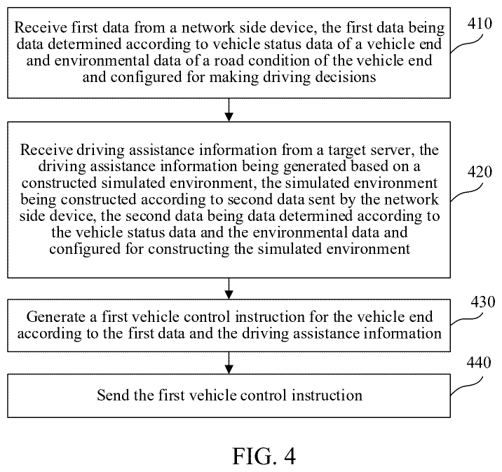

FIG. 3 is an illustration according to some embodiments from the perspective of the network side device. Details of some embodiments are described below with reference to FIG. 4 from the perspective of the remote driving server:

FIG. 4 is a flowchart of a remote driving control method according to some embodiments. The remote driving control method may be performed by a remote driving server, which may be, for example, the remote driving server 204 shown in FIG. 2. Referring to FIG. 4, the remote driving control method includes at least 410 to 440. A detailed description is as follows:

410: Receive first data from a network side device, the first data being data determined according to vehicle status data of a vehicle and environmental data of a road condition of the vehicle and configured for making driving decisions.

For example, the first data sent by the network side device may be received. The first data is data determined by the network side device according to the vehicle status data of the vehicle and the environmental data of the road condition of the vehicle and configured for making driving decisions.

In some embodiments, structured data and unstructured data may be selected from the vehicle status data and the environmental data. Then, the unstructured data is used as the first data and sent to the remote driving server, so that the remote driving server makes driving decisions based on the first data.

420: Receive driving assistance information from a target server, the driving assistance information being generated based on a constructed simulated environment, the simulated environment being constructed according to second data sent by the network side device, the second data being data determined according to the vehicle status data and the environmental data and configured for constructing the simulated environment.

For example, the driving assistance information fed back by the target server based on the constructed simulated environment may be received. The simulated environment is constructed by the target server according to the second data sent by the network side device. The second data is data determined by the network side device according to the vehicle status data and the environmental data and configured for constructing the simulated environment.

In some embodiments, the driving assistance information fed back by the target server may be, for example, at least one of a real-time video stream of the simulated environment, prediction information for the road condition of the vehicle, driving advice information obtained through analysis, and network prediction information of the vehicle. In some embodiments, the second data may be the structured data in the vehicle status data and the environmental data, or may be the structured data and the unstructured data in the vehicle status data and the environmental data.

430: Generate a first vehicle control instruction for the vehicle according to the first data and the driving assistance information.

440: Send the first vehicle control instruction.

For example, the first vehicle control instruction may be sent to the vehicle.

In some embodiments, the first vehicle control instruction may be at least one of slowing down, reducing a data transmission bit rate, reducing a video capturing bit rate of a camera, stopping in a specified region (such as pulling over), and switching driving modes.

In some embodiments, the remote driving server may generate a vehicle control instruction (referred to as a second vehicle control instruction for ease of distinction) for the vehicle according only to the first data. Specifically, the first data may include a traveling status and a network status of the vehicle. If the traveling status and the network status of the vehicle do not match a current remote driving mode of the vehicle, a control instruction on switching the remote driving mode of the vehicle may be generated. If the network status of the vehicle indicates that current network communication quality of the vehicle is lower than a set threshold, a control instruction on reducing a data transmission bit rate of the vehicle is generated. If the traveling status of the vehicle indicates that there is a driving risk on a road section on which the vehicle is traveling, a control instruction on reducing a traveling speed of the vehicle is generated, or a control instruction on parking in a specified region is generated.

In some embodiments shown in FIG. 4, the remote driving server can both individually control the vehicle according to the first data sent by the network side device, and generate the vehicle control instruction according to the first data and the driving assistance information fed back by the target server, so that remote driving decisions can be reached based on a larger amount of more comprehensive information, thereby helping improve the safety of remote driving.

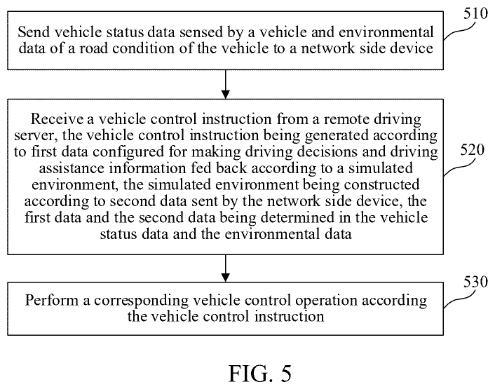

The foregoing descriptions of some embodiments are provided from the perspectives of the network side device and the remote driving server, respectively. Some embodiments are described below with reference to FIG. 5 from the perspective of the vehicle:

FIG. 5 is a flowchart of a remote driving control method according to some embodiments. The remote driving control method may be performed by a vehicle, which may be, for example, the vehicle 201 shown in FIG. 2. Referring to FIG. 5, the remote driving control method includes at least 510 to 530. A detailed description is as follows:

510: Send vehicle status data detected by a vehicle and environmental data of a road condition of the vehicle to a network side device.

In some embodiments, the vehicle status data may be, for example, at least one of a speed, acceleration, direction angle, vehicle location information, network status, and other data. The environmental data of the road condition of the vehicle may be, for example, information about anomalies of other traffic participants surrounding the vehicle or roads, such as at least one of road traffic events, vehicle anomalies, road obstacles, road surface statuses, and other information.

In some embodiments, before sending the detected vehicle status data and the environmental data to the network side device, the vehicle may further convert partial data that can be structured in the vehicle status data and the environmental data into structured data, and then send data in the vehicle status data and the environmental data other than the partial data that can be converted into structured data and the structured data obtained through conversion to the network side device.

520: Receive a vehicle control instruction from a remote driving server, the vehicle control instruction being generated according to first data configured for making driving decisions and driving assistance information fed back according to a simulated environment, the simulated environment being constructed according to second data sent by the network side device, the first data and the second data being determined in the vehicle status data and the environmental data.

For example, a vehicle control instruction forwarded by the network side device may be received. The vehicle control instruction is generated by the remote driving server according to the first data configured for making driving decisions and the driving assistance information fed back by the target server according to the simulated environment. The simulated environment is constructed by the target server according to the second data sent by the network side device. The first data and the second data are determined by the network side device in the vehicle status data and the environmental data.

530: Perform a corresponding vehicle control operation according to the vehicle control instruction.

In some embodiments, the vehicle control instruction may be at least one of slowing down, reducing a data transmission bit rate, reducing a video capturing bit rate of a camera, stopping in a specified region (such as pulling over), and switching driving modes.

In some embodiments shown in FIG. 5, the vehicle can perform the corresponding vehicle control operation according to the vehicle control instruction sent by the remote driving server, and the remote driving server can generate the vehicle control instruction according to the first data and the driving assistance information fed back by the target server, so that remote driving decisions can be reached based on a larger amount of more comprehensive information, thereby helping improve the safety of remote driving.

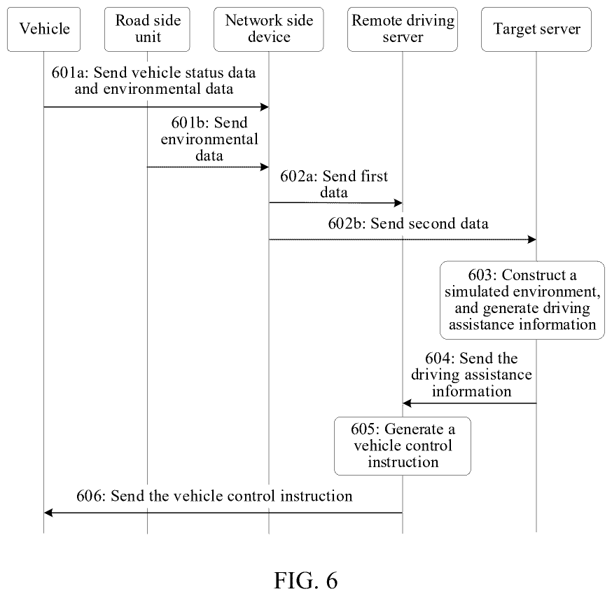

Some embodiments are described below with reference to FIG. 6 from the perspective of interaction between the vehicle, the RSU, the network side device, the remote driving server, and the target server:

Referring to FIG. 6, a remote driving control method, according to some embodiments, includes the following blocks:

601a: A vehicle sends vehicle status data and environmental data to a network side device.

In some embodiments, the vehicle status data may be, for example, at least one of a speed, acceleration, direction angle, vehicle location information, network status, and other data of the vehicle. The environmental data is environmental data of a road condition of the vehicle, and may be, for example, information about anomalies of other traffic participants surrounding the vehicle or roads, such as at least one of road traffic events, vehicle anomalies, road obstacles, road surface statuses, and other information.

601b: An RSU sends environmental data to the network side device.

There is no sequential order between 601a and 601b. For example, the RSU may send the environmental data to the network side device based on collecting the environmental data, and the vehicle may also send the vehicle status data and the environmental data collected in real time to the network side device.

602a: The network side device sends first data to a remote driving server.

In some embodiments, structured data and unstructured data may be selected from the vehicle status data and the environmental data. Then, the unstructured data is used as the first data and sent to the remote driving server, so that the remote driving server makes driving decisions based on the first data.

602b: The network side device sends second data to a target server.

In some embodiments, the second data may be the structured data in the vehicle status data and the environmental data, or may be the structured data and the unstructured data in the vehicle status data and the environmental data.

603: The target server constructs a simulated environment, and generates driving assistance information

In some embodiments, the driving assistance information may be, for example, at least one of a real-time video stream of the simulated environment, prediction information for the road condition of the vehicle, driving advice information obtained through analysis, and network prediction information of the vehicle.

604: The target server sends the driving assistance information to the remote driving server.

605: The remote driving server generates a vehicle control instruction.

The remote driving server may generate the vehicle control instruction according to the first data and the driving assistance information. The remote driving server may generate the vehicle control instruction according only to the first data. The vehicle control instruction may be, for example, at least one of speeding up, slowing down, reducing a data transmission bit rate, reducing a video capturing bit rate of a camera, stopping in a specified region, and switching driving modes.

606: The remote driving server sends the vehicle control instruction to the vehicle.

According to some embodiments shown in FIG. 6, environment construction and analysis and processing tasks of the road condition of the vehicle can be performed on the target server. In this way, the impact on a network bandwidth of the remote driving server can be alleviated by reducing a volume of data transmitted to the remote driving server, thereby reducing the probability of driving risks caused by network quality deterioration. The remote driving server generates the vehicle control instruction according to the first data and the driving assistance information fed back by the target server, so that the remote driving server can reach remote driving decisions based on a larger amount of more comprehensive information, thereby helping improve the safety of remote driving.

According to some embodiments, at least one of the RSU and the vehicle sends collected roadside and vehicle-related data to a communication device (for example, the network side device) through a network (for example, a 5G network), and then the communication device uploads the data to the remote driving server. In addition, structured data and unstructured data may be selectively sent to a twin server (for example, the target server). The twin server is responsible for scene rendering processing to generate a road environment of the vehicle, then presenting the road environment of the vehicle, performing situational awareness operations such as simulation deduction and calculation, then presenting them at the remote driving server (for example, a remote cockpit), and feeding back a situational awareness result to the remote driving server. The remote driving server can directly perform analysis and determining (prediction) on the vehicle, and notify the vehicle of a control instruction (for example, at least one of slowing down, reducing a camera bit rate, taking over by a safety officer of a remotely driven vehicle, and pulling over). Additionally, the remote driving server can deliver, to the remotely driven vehicle, a control instruction generated with reference to feedback information returned by the twin server. A current traffic condition can be comprehensively analyzed, and some traffic scenarios can be analyzed and determined on the twin server. This saves the network bandwidth of the remote driving server and thus reduces the probability of accidents caused by network quality deterioration.

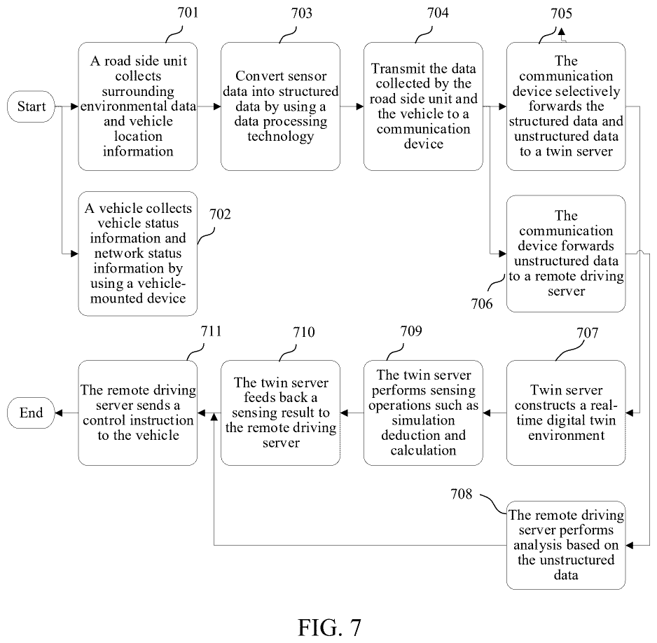

Specifically, as shown in FIG. 7, a remote driving control method, according to some embodiments, includes 701 to 711. 701 to 706 show that an RSU and a vehicle collect information, and upload data to a remote driving server and a twin server through a communication device and a core network; the twin server performs scene rendering processing to generate a road environment of the vehicle, then presents the road environment of the vehicle, and performs situational awareness operations such as simulation deduction and calculation. Details are provided as follows:

701: An RSU is responsible for collecting surrounding road condition information, image information, and the like, including information configured for reconstructing a real-time digital twin environment that is consistent with reality. For example, the information may include at least one of a static target and a dynamic target. The static target may be converted into structured data, and passed to a twin server through a communication link to construct the twin environment. The dynamic target may be passed to the twin server to construct the twin environment, and may assist the twin server in situational awareness. The RSU refers to a device capable of capturing a video, an image, and a surrounding geographical location environment, and may be, for example, one or more of a camera, a sensor, a millimeter wave radar, and a LiDAR.

702: Collect vehicle status information and network status information by using a vehicle. The vehicle status information includes at least one of a speed, location information, acceleration, a direction angle, and other information of a vehicle. The location information of the vehicle may be positioned through a navigation and positioning system carried by the vehicle, like satellite-based radio navigation system devices such as the Global Positioning System (GPS) or BeiDou Navigation Satellite System. The network status information includes at least one of an SINR, an RSSI, RSRP, RSRQ, latency information, a throughput, a physical downlink shared channel transport block size, a modulation and coding scheme, a rate of a downloaded fragment, duration of the downloaded fragment, a bit rate of an optional fragment, a size of a buffer, a quantity of remaining undownloaded fragments, and a bit rate for downloading a previous fragment. The vehicle refers to a vehicle-mounted device, such as a mobile terminal located in the vehicle or a vehicle-mounted camera.

In addition to collecting information by a terminal side (such as the vehicle) and reporting processed data to a remote driving server and a twin server, data (such as network status information) may also be collected through a network side (such as a base station) and the data is sent to the remote driving server and the twin server in real time.

703: Convert partial detected data and vehicle status information into structured data by using a data processing technology. The vehicle or the RSU transmits, through the structured data, information about a road environment, for example, at least one of a quantity of surrounding vehicles in the road environment, the orientation of the surrounding vehicles, and whether the road condition falls in a ring road, a tunnel, or the like. The structured data may be configured for constructing a real-time twin environment on the twin server.

Three data processing technologies may be included in some embodiments: A first method is structured data cleaning. For example, cleaning out erroneous data according to one or more rules. Data cleaning may filter out data that does not meet requirements. A second method is deep learning. Deep learning can find semantic features of the structured data, and make the data scalable by finding automated methods with little or no human intervention by resolving problems of manual data cleaning and preparation. A third method is a decision tree. This method is prevalent in various application software and systems, such as product data storage and transaction logs. The method may require manual feature extraction and performs structured processing through model training.

704: Upload the structured data and unstructured data collected by the vehicle and the RSU to a communication device through an uplink transmission link. The communication device refers to an active communication device that can serve as a transmitter, including one or more of a 4G/5G base station, an RSU, or Wi-Fi. If the transmission is performed through a 5G network, a 5G system is required to support real-time transmission of structured and unstructured data generated by road infrastructure.

705: The communication device selectively sends the structured data and the unstructured data to the twin server through a core network by using a relevant interface. The twin server receives the data and is responsible for scene rendering processing to generate a road environment of the vehicle, then presenting the road environment of the vehicle, and performing situational awareness operations such as simulation deduction and calculation.

706: The communication device forwards the unstructured data on the vehicle side and the road side to a remote driving server. The remote driving server can directly perform analysis and determining (prediction) on the vehicle, and notify a remotely driven vehicle of an instruction (for example, at least one of slowing down, reducing a camera bit rate, taking over by a safety officer of the remotely driven vehicle, and pulling over).

707 to 711 in FIG. 7 describe that, according to some embodiments, the twin server performs scene rendering processing to generate a road environment of the vehicle, then presents the road environment of the vehicle, performs situational awareness operations such as simulation deduction and calculation, then presents them at the remote driving server, and feeds back a situational awareness result to the remote driving server. The remote driving server can directly perform analysis and determining (prediction) on the vehicle, and notify the remotely driven vehicle of the instruction (for example, at least one of slowing down, reducing a camera bit rate, taking over by a safety officer of the remotely driven vehicle, and pulling over). Additionally, the remote driving server delivers, to the remotely driven vehicle, a control instruction generated with reference to feedback information returned by the twin server. Details are provided as follows:

707: The twin server selectively receives the structured data and the unstructured data, performs rendering processing on the data to generate a road environment of the vehicle, and then presents the road environment of the vehicle at the remote driving server. Due to the proximity of logical locations of the twin server and the remote driving server, the environment may be considered as being rendered and presented within a local area network. The impact of this part of latency on remote driving services can be ignored.

708: The remote driving server performs analysis and determining (prediction) on the remotely driven vehicle based on the information about the vehicle and the unstructured data. For example, a future network status may be predicted according to remote driving vehicle status information and network status information received by the remote driving server, and then the remote driving server delivers a control instruction to the remotely driven vehicle.

709: The twin server performs situational awareness operations such as simulation deduction and calculation. For example, when there is construction ahead on the road of the vehicle, hindering normal traveling on the lane of the vehicle, the twin server can detect a twin vehicle to control the twin vehicle to perform a lane change operation, which can be mapped to the vehicle in the real environment.

710: The twin server feeds back a situational awareness result to a remote control server, and the remote control server generates a remote control instruction with reference to the feedback from the twin server and delivers the instruction to the remotely driven vehicle.

711: The remote driving server can directly perform analysis and determining (prediction) on the vehicle, and notify the remotely driven vehicle of an instruction (for example, at least one of slowing down, reducing a camera bit rate, taking over by a safety officer of a remotely driven vehicle, and pulling over) through a network, such as a vehicle-to-everything (5G-V2X) downlink link. Additionally, the remote driving server can generate a control instruction with reference to the feedback information returned by the twin server and deliver the control instruction to the remotely driven vehicle.

In some embodiments, the impact on a network bandwidth of the remote driving server is alleviated by reducing a volume of data transmitted to the remote driving server, thereby reducing the probability of driving risks caused by network quality deterioration. In addition, the remote driving server is enabled to reach remote driving decisions based on a larger amount of more comprehensive information, thereby helping improve the safety of remote driving.

The following describes some embodiments which may be configured to perform the remote driving control methods.

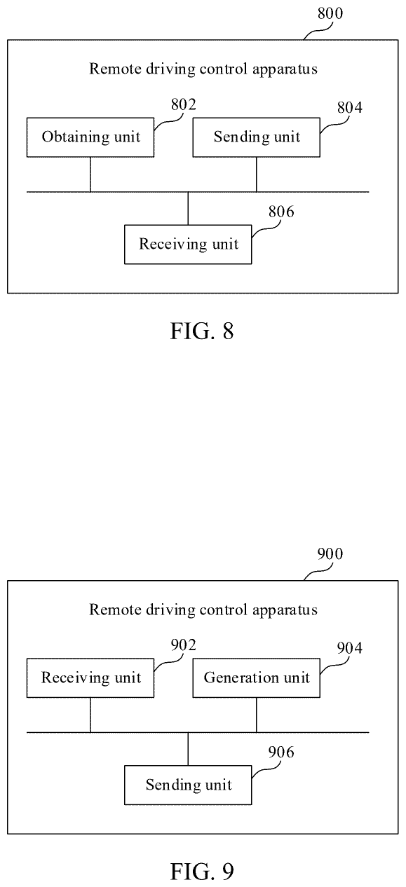

FIG. 8 is a block diagram of a remote driving control apparatus according to some embodiments. The remote driving control apparatus may be disposed in a network side device. The network side device may be an access network device, for example, the communication device 203 shown in FIG. 2.

Referring to FIG. 8, a remote driving control apparatus 800, according to some embodiments, includes: an obtaining unit 802, a sending unit 804, and a receiving unit 806.

The obtaining unit 802 is configured to obtain vehicle status data of a vehicle and environmental data of a road condition of the vehicle. The sending unit 804 is configured to determine, according to the vehicle status data and the environmental data, first data configured for making driving decisions and second data configured for constructing a simulated environment corresponding to the road condition, and send the first data to a remote driving server and send the second data to a target server in communication connection with the remote driving server. The receiving unit 806 is configured to receive a vehicle control instruction from the remote driving server, the vehicle control instruction being generated based on the first data and driving assistance information fed back by the target server, the driving assistance information being generated according to the constructed simulated environment. The sending unit 804 is further configured to: send the vehicle control instruction to the vehicle.

In some embodiments, based on the foregoing solution, that the obtaining unit 802 obtains the vehicle status data of the vehicle and the environmental data of the road condition of the vehicle includes at least one of the following manners: receiving the vehicle status data and the environmental data detected by a vehicle-mounted device disposed on the vehicle; and receiving the vehicle status data and the environmental data detected by an RSU configured on a road section on which the vehicle is traveling.

In some embodiments, the vehicle status data of the vehicle includes a network status of the vehicle; and the obtaining unit 802 is configured to receive the network status sent by the vehicle, or obtain the network status of the vehicle detected by the network side device.

In some embodiments, the sending unit 804 may be configured to: select structured data and unstructured data from the vehicle status data and the environmental data; use the unstructured data as the first data; and use the structured data as the second data, or use the structured data and the unstructured data as the second data.

FIG. 9 is a block diagram of a remote driving control apparatus according to some embodiments. The remote driving control apparatus may be disposed in a remote driving server, and for example, may be the remote driving server 204 shown in FIG. 2.

Referring to FIG. 9, a remote driving control apparatus 900, according to some embodiments, includes: a receiving unit 902, a generation unit 904, and a sending unit 906.

The receiving unit 902 is configured to receive first data from a network side device, the first data being data determined according to vehicle status data of a vehicle and environmental data of a road condition of the vehicle and configured for making driving decisions; and receive driving assistance information from a target server, the driving assistance information being generated based on a constructed simulated environment, the simulated environment being constructed according to second data transmitted by the network side device, the second data being data determined according to the vehicle status data and the environmental data and configured for constructing the simulated environment. The generation unit 904 is configured to generate a first vehicle control instruction for the vehicle according to the first data and the driving assistance information. The sending unit 906 is configured to send the first vehicle control instruction.

In some embodiments, the first data includes a traveling status and a network status of the vehicle. The generation unit 904 is further configured to: generate a second vehicle control instruction for the vehicle according to at least one of the traveling status and the network status of the vehicle. The sending unit is further configured to send the second vehicle control instruction to the vehicle.

In some embodiments, that the generation unit 904 generates a second vehicle control instruction for the vehicle according to at least one of the traveling status and the network status of the vehicle includes at least one of the following:
generating a control instruction on switching a remote driving mode of the vehicle if the traveling status and the network status of the vehicle do not match the current remote driving mode of the vehicle, the remote driving mode of the vehicle including an MRC mode and an HRC mode;
generating a control instruction on reducing a data transmission bit rate of the vehicle if the network status of the vehicle indicates that current network communication quality of the vehicle is lower than a set threshold; and
generating a control instruction on reducing a traveling speed of the vehicle or generating a control instruction on parking in a specified region if the traveling status of the vehicle indicates that there is a driving risk on a road section on which the vehicle is traveling.

In some embodiments, the driving assistance information includes at least one of the following: real-time video information of the simulated environment, prediction information for the road condition of the vehicle, driving advice information, and network prediction information.

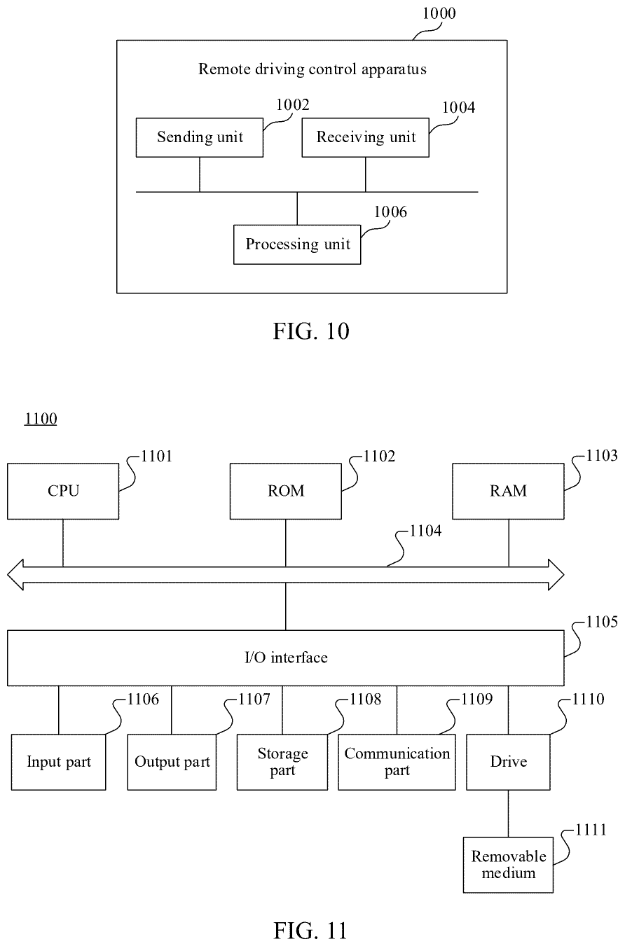

FIG. 10 is a block diagram of a remote driving control apparatus according to some embodiments. The remote driving control apparatus may be disposed in a vehicle, and for example, may be the vehicle 201 shown in FIG. 2.

Referring to FIG. 10, the remote driving control apparatus 1000, according to some embodiments, includes: a sending unit 1002, a receiving unit 1004, and a processing unit 1006.

The sending unit 1002 is configured to send vehicle status data detected by a vehicle and environmental data of a road condition of the vehicle to a network side device. The receiving unit 1004 is configured to receive a vehicle control instruction from a remote driving server, the vehicle control instruction being generated according to first data configured for making driving decisions and driving assistance information fed back according to a simulated environment, the simulated environment being constructed according to second data sent by the network side device, the first data and the second data being determined in the vehicle status data and the environmental data. The processing unit 1006 is configured to perform a corresponding vehicle control operation according to the vehicle control instruction.

In some embodiments, the sending unit 1002 is configured to: convert partial data that can be structured in the vehicle status data and the environmental data into structured data; and send data in the vehicle status data and the environmental data other than the partial data and the structured data obtained through conversion to the network side device.

According to some embodiments, each unit in the apparatus may exist respectively or be combined into one or more units. Certain (or some) unit in the units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each module and unit are executable by a processor to thereby cause the processor to perform the respective operations of the corresponding module and unit.

FIG. 11 is a schematic structural diagram of a computer system adapted to implement an electronic device according to some embodiments.

The computer system 1100 of the electronic device shown in FIG. 11 is merely an example and is not to constitute any limitation on function or scope of the disclosure.

As shown in FIG. 11, the computer system 1100 includes a central processing unit (CPU) 1101, which may perform various suitable actions and processing based on a program stored in a read-only memory (ROM) 1102 or a program loaded from a storage part 1108 into a random access memory (RAM) 1103, for example, perform the method described in some embodiments. The RAM 1103 further stores various programs and data required for system operations. The CPU 1101, the ROM 1102, and the RAM 1103 are connected to one another through a bus 1104. An input/output (I/O) interface 1105 is also connected to the bus 1104.

The following components are connected to the I/O interface 1105: an input part 1106 including a keyboard, a mouse, or the like; an output part 1107 including a cathode ray tube (CRT), a liquid crystal display (LCD), a speaker, or the like; the storage part 1108 including a hard disk, or the like; and a communication part 1109 including a network interface card such as a local area network (LAN) card or a modem. The communication part 1109 performs communication processing by using a network such as the Internet. A drive 1110 may also connect to the I/O interface 1105. A removable medium 1111, such as a magnetic disk, an optical disk, a magneto-optical disk, or a semiconductor memory, may be mounted on the drive 1110, so that a computer program read therefrom may be installed into the storage part 1108.

According to some embodiments, the processes described above with reference to the flowcharts may be implemented as computer software programs. For example, some embodiments include a computer program product. The computer program product includes a computer program stored in a computer-readable medium. The computer program includes a computer program configured for performing the method shown in the flowchart. In such an embodiment, the computer program may be downloaded from a network and installed through the communication part 1109, and/or installed from the removable medium 1111. When the computer program is executed by the CPU 1101, the various functions defined in the system are performed.

The computer-readable medium shown in some embodiments may be a computer-readable signal medium or a computer-readable storage medium or any combination thereof. The computer-readable storage medium may be, for example, but is not limited to, an electric, magnetic, optical, electromagnetic, infrared, or semi-conductive system, apparatus, or component, or any combination of thereof. A computer-readable storage medium may include, but is not limited to: an electrical connection having one or more wires, a portable computer magnetic disk, a hard disk, a RAM, a ROM, an erasable programmable read-only memory (EPROM), a flash memory, an optical fiber, a compact disk read-only memory (CD-ROM), an optical storage device, a magnetic storage device, or any appropriate combination thereof. The computer-readable storage medium may be any tangible medium containing or storing a program, and the program may be used by or used in combination with an instruction execution system, apparatus, or device. The computer-readable signal medium may include a data signal propagated in a baseband or as part of a carrier, having a computer-readable computer program carried therein. A data signal propagated in such a way may be in a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in conjunction with an instruction execution system, apparatus, or device. The computer program contained on the computer-readable medium may be transmitted using any suitable medium, including but not limited to: a wireless medium, a wired medium, or the like, or any appropriate combination thereof.

The flowcharts and block diagrams in the accompanying drawings illustrate system architectures, functions, and operations that may be implemented by a system, a method, and a computer program product according to some embodiments. Each block in a flowchart or a block diagram may represent a module, a program segment, or a part of code. The module, program segment, or part of code contains one or more executable instructions configured for implementing defined logical functions. In some embodiments, functions annotated in the blocks may occur in an order different from that annotated in the accompanying drawings. For example, two blocks shown in succession may be performed in parallel, and sometimes the two blocks may be performed in a reverse order. This depends on the functions involved. Each block in the block diagram and/or flowchart and a combination of blocks in the block diagram and/or the flowchart may be implemented by using a dedicated hardware-based system configured to perform a defined function or operation, or may be implemented by using a combination of dedicated hardware and a computer program.

Units involved and described in some embodiments may be implemented in the form of software or in the form of hardware. The described units may also be disposed in the processor. Names of the units do not constitute a limitation on the units.

A computer-readable medium is provided according to some embodiments. The computer-readable medium may be included in the electronic device, or may exist alone and is not disposed in the electronic device. The computer-readable medium carries one or more programs, the one or more programs, when executed by the electronic device, causing the electronic device to implement the method described in some embodiments.

Although a plurality of modules or units of a device configured to perform actions are discussed, such division is not mandatory. The features and functions of two or more modules or units described above may be embodied in one module or unit. On the contrary, the features and functions of one module or unit described above may be further divided to be embodied by a plurality of modules or units.

A person skilled in the art may readily understand that the examples of some embodiments described herein may be implemented by software, or by software in combination with hardware. Therefore, the technical solutions of some embodiments may be implemented in the form of a software product. The software product may be stored in a non-volatile storage medium (which may be a CD-ROM, a USB flash drive, a removable hard disk, or the like) or on the network, including a plurality of instructions for instructing a computing device (which may be a personal computer, a server, a touch terminal, a network device, or the like) to perform the methods according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A remote driving control method, comprising:
obtaining vehicle status data of a vehicle and environmental data of a road condition of the vehicle;
determining first data for making driving decisions and second data for constructing a simulated environment corresponding to the road condition, based on the vehicle status data and the environmental data;
transmitting the first data to a remote driving server;
transmitting the second data to a target server, the target server and the remote driving server being connected via a network;
receiving a first vehicle control instruction from the remote driving server; and
transmitting the first vehicle control instruction to the vehicle,
wherein the first vehicle control instruction is generated based on the first data and driving assistance information transmitted from the target server, and
wherein the driving assistance information is generated based on the constructed simulated environment.

2. The remote driving control method according to claim 1, wherein the obtaining the vehicle status data comprises at least one of:
receiving the vehicle status data and the environmental data from a vehicle-mounted device disposed on the vehicle;
receiving the vehicle status data and the environmental data from a mobile terminal inside the vehicle; or
receiving the vehicle status data and the environmental data from a road side unit (RSU) of a road section on which the vehicle end is traveling.

3. The remote driving control method according to claim 1,
wherein the vehicle status data of the vehicle comprises a network status of the vehicle, and
wherein the obtaining the vehicle status data comprises at least one of:
receiving the network status from the vehicle; or
detecting the network status of the vehicle.

4. The remote driving control method according to claim 1,
wherein the determining the first data and the second data comprises selecting structured data and unstructured data from the vehicle status data and the environmental data,
wherein the determining the first data further comprises determining the unstructured data as the first data, and
wherein the determining the second data further comprises:
determining the structured data as the second data; or
determining the structured data and the unstructured data as the second data.

5. The remote driving control method according to claim 1,
wherein the first data comprises a traveling status and a network status of the vehicle, and
wherein the method further comprises:
generating a second vehicle control instruction for the vehicle according to at least one of the traveling status and the network status; and
transmitting the second vehicle control instruction to the vehicle.

6. The remote driving control method according to claim 5, wherein the second vehicle control instruction comprises at least one of:
a first control instruction for switching a remote driving mode of the vehicle based on the traveling status and the network status not corresponding to a current remote driving mode of the vehicle;
a second control instruction for reducing a data transmission bit rate of the vehicle based on the network status of the vehicle indicating a current network communication quality of the vehicle is lower than a set threshold; or
a third control instruction based on the traveling status of the vehicle indicating a driving risk on a road section on which the vehicle is traveling for at least one of:
reducing a traveling speed of the vehicle; or
parking in a specified region, and
wherein the remote driving mode comprises a machine remote control (MRC) mode or a human remote control (HRC) mode.

7. The remote driving control method according to claim 5, wherein the driving assistance information comprises at least one of: real-time video information of the simulated environment, prediction information for the road condition, driving advice information, or network prediction information.

8. The remote driving control method according to claim 1, wherein the determining the first data and the second data comprises:
converting partial data of the vehicle status data and the environmental data into structured data, and
determining the first data and the second data from the vehicle status data and the environmental data other than the partial data converted to the structured data.

9. A remote driving control apparatus, comprising:
at least one memory configured to store computer program code;
at least one processor configured to read the program code and operate as instructed by the program code, the program code comprising:
obtaining code configured to cause at least one of the at least one processor to obtain vehicle status data of a vehicle and environmental data of a road condition of the vehicle;
first determining code configured to cause at least one of the at least one processor to determine first data configured for making driving decisions and second data configured for constructing a simulated environment corresponding to the road condition, based on the vehicle status data and the environmental data;
transmitting code configured to cause at least one of the at least one processor to:
transmit the first data to a remote driving server, and
transmit the second data to a target server, the target server and the remote driving server being connected via a network;
first receiving code configured to cause at least one of the at least one processor to receive a first vehicle control instruction from the remote driving server; and
first sending code configured to cause at least one of the at least one processor to transmit the first vehicle control instruction to the vehicle,
wherein the first vehicle control instruction is generated based on the first data and driving assistance information transmitted from the target server, and
wherein the driving assistance information is generated according to the constructed simulated environment.

10. The remote driving control apparatus according to claim 9, wherein the obtaining code further comprises at least one of second receiving code, third receiving code, or fourth receiving code,
wherein the second receiving code is configured to cause at least one of the at least one processor to receive the vehicle status data and the environmental data from a vehicle-mounted device disposed on the vehicle,
wherein the third receiving code is configured to cause at least one of the at least one processor to receive the vehicle status data and the environmental data from a mobile terminal inside the vehicle, and
wherein the fourth receiving code is configured to cause at least one of the at least one processor to receive the vehicle status data and the environmental data from a road side unit (RSU).

11. The remote driving control apparatus according to claim 9,
wherein the vehicle status data of the vehicle comprises a network status of the vehicle, and
wherein the obtaining code is further configured to cause at least one of the at least one processor to:
receive the network status from the vehicle; or
detect the network status of the vehicle.

12. The remote driving control apparatus according to claim 9,
wherein the first determining code is further configured to cause at least one of the at least one processor to:
select structured data and unstructured data from the vehicle status data and the environmental data, and
determine the unstructured data as the first data,
wherein the first determining code further comprises second determining code or third determining code,
wherein the second determining code is configured to cause at least one of the at least one processor to determine the structured data as the second data, and
wherein the third determining code is configured to cause at least one of the at least one processor to determine the structured data and the unstructured data as the second data.

13. The remote driving control apparatus according to claim 9,
wherein the first data comprises a traveling status and a network status of the vehicle,
wherein the program code further comprises first generating code and second sending code,
wherein the first generating code is configured to cause at least one of the at least one processor to generate a second vehicle control instruction for the vehicle according to at least one of the traveling status and the network status, and
wherein the second sending code is configured to cause at least one of the at least one processor to transmit the second vehicle control instruction to the vehicle.

14. The remote driving control apparatus according to claim 13, wherein the second vehicle control instruction comprises at least one of:
a first control instruction for switching a remote driving mode of the vehicle based on the traveling status and the network status not corresponding to a current remote driving mode of the vehicle,
a second control instruction for reducing a data transmission bit rate of the vehicle based on the network status of the vehicle indicating a current network communication quality of the vehicle is lower than a set threshold, or
a third control instruction based on the traveling status of the vehicle indicating a driving risk on a road section on which the vehicle is traveling for at least one of:
reducing a traveling speed of the vehicle; or
parking in a specified region, and
wherein the remote driving mode comprises a machine remote control (MRC) mode or a human remote control (HRC) mode.

15. The remote driving control apparatus according to claim 13, wherein the driving assistance information comprises at least one of: real-time video information of the simulated environment, prediction information for the road condition, driving advice information, or network prediction information.

16. The remote driving control apparatus according to claim 9, wherein the first determining code is further configured to cause at least one of the at least one processor to:
convert partial data of the vehicle status data and the environmental data into structured data, and
determine the first data and the second data from the vehicle status data and the environmental data other than the partial data converted to the structured data.

17. A non-transitory computer-readable storage medium, storing computer code which, when executed by at least one processor, causes the at least one processor to at least:
obtain vehicle status data of a vehicle and environmental data of a road condition of the vehicle;
determine first data configured for making driving decisions and second data configured for constructing a simulated environment corresponding to the road condition, based on the vehicle status data and the environmental data;
transmit the first data to a remote driving server;
transmit the second data to a target server, the target server and the remote driving server being connected via a network;
receive a first vehicle control instruction from the remote driving server; and
transmit the first vehicle control instruction to the vehicle,
wherein the first vehicle control instruction is generated based on the first data and driving assistance information transmitted from the target server, and
wherein the driving assistance information is generated according to the constructed simulated environment.

18. The non-transitory computer-readable storage medium according to claim 17, wherein the obtaining the vehicle status data comprises at least one of:
receiving the vehicle status data and the environmental data from a vehicle-mounted device disposed on the vehicle;
receiving the vehicle status data and the environmental data from a mobile terminal inside the vehicle; or
receiving the vehicle status data and the environmental data from a road side unit (RSU).

19. The non-transitory computer-readable storage medium according to claim 17,
wherein the vehicle status data of the vehicle comprises a network status of the vehicle, and
wherein the obtaining the vehicle status data comprises at least one of:
receiving the network status from the vehicle; or
detecting the network status of the vehicle.

20. The non-transitory computer-readable storage medium according to claim 17,
wherein the determining the first data and the second data comprises selecting structured data and unstructured data from the vehicle status data and the environmental data,
wherein the determining the first data further comprises determining the unstructured data as the first data, and
wherein the determining the second data further comprises:
determining the structured data as the second data; or
determining the structured data and the unstructured data as the second data.
